(19) United States
(12) Patent Application Publication
(10) Pub. No.: US 2007/0267989 A1
(43) Pub. Date: Nov. 22, 2007

(54) Apparatus, optical disc drive, and method of controlling the optical disc drive

(75) Inventor: Jak Heun Yang, Suwon-Si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/582,976

(22) Filed: Oct. 19, 2006

(30) Foreign Application Priority Data
May 16, 2006 (KR) 2006-44003

(51) Int. Cl. H02P 7/00

(52) U.S. Cl. 318/432

(57) ABSTRACT

An apparatus includes a motor that is rotatable; a lead screw including a thread part, the lead screw being rotatably coupled to the motor so that the lead screw rotates when the motor rotates; a moving member reciprocatably coupled to the thread part of the lead screw; and a control unit that controls a magnitude of electric power supplied to the motor so that when a mechanical locking has occurred between the thread part of the lead screw and the moving member, the motor generates a torque having a magnitude and a direction effective to release the mechanical locking.

### CROSS-REFERENCE TO RELATED APPLICATION

This application claims the benefit of Korean Patent Application No. 2006-44003 filed on May 16, 2006, in the Korean Intellectual Property Office, the disclosure of which is incorporated herein by reference.

### BACKGROUND OF THE INVENTION

1. Field of the Invention

An aspect of the invention relates to an apparatus including a moving member movable by the interaction between a screw and a nut, and, more particularly, to an optical disc drive including a lens holder linearly movable by the interaction between a lead screw and a nut (or its substitute) and a method of controlling the optical disc drive.

2. Description of the Related Art

In the case of recording and reproducing data on and from an optical disc, which is a large-capacity data recording media, the data recording density of the optical disc is increased as the size of a light spot formed at a data recording surface of the optical disc by an optical pickup is decreased. The size of the light spot is decreased as the wavelength A of a light used in the optical pickup is decreased or as the numerical aperture of an object lens is increased, as expressed by the following equation (1):

$$Size of light spot ∝ \frac{λ}{NA} \qquad ( 1 )$$

Consequently, a Blu-ray disc (BD), which has a recording density higher than a conventional compact disc (CD) and a conventional digital versatile disc (DVD), has been developed and used. In the case of the BD, a blue laser light source having a short wavelength of 405 nm and an object lens having a high numerical aperture of 0.85 are used in the optical pickup for recording and reproducing data with the result that the data recording capacity extends to 23 to 27 GB for each BD. Also, the thickness of a substrate of the BD is decreased to 0.1 mm, which is less than that of the CD (1.2 mm) and that of the DVD (0.6 mm), in order to prevent the degradation of performance due to the inclination of the optical disc.

FIG. 1 is a view of a section of an optical disc. As shown in FIG. 1, the thickness of a substrate means the thickness from a light incidence surface 102 to a data recording surface 104. In FIG. 1, reference numeral 106 indicates an optical pickup, and reference numeral 108 indicates light emitted from the optical pickup.

In the optical pickup for recording and reproducing data on and from the optical disc having the high-density recording capacity as described above, a lens having a large numerical aperture is used to reduce the diameter of a beam focused by an object lens. As a result, when the thickness of the substrate, on which luminous flux is focused, is deviated from a predetermined thickness, large spherical aberration occurs. Specifically, the spherical aberration is proportional to the 4th power of the numerical aperture and is proportional to the thickness deviation Δd of the substrate of the optical disc, as expressed by the following equation (2). Consequently, it is necessary to reduce the thickness error range of the substrate of the optical disc so that the spherical aberration is minimized, in order to adopt an object lens having a high numerical aperture of approximately 0.85:

$$Spherical aberration = \frac{( {n}^{2} - 1 )}{8 {n}^{3}} {( NA )}^{4} Δ d \qquad ( 2 )$$

FIG. 2 is a graph of a relation between a thickness error of a substrate of an optical disc and a wavefront aberration of an optical pickup for Blu-ray discs (BDs) (hereinafter, referred to as a “BD optical pickup”), which includes a blue laser light source having a wavelength of 405 nm and an object lens having a numerical aperture of 0.85. The wavefront aberration is a combined aberration including the spherical aberration. As shown in FIG. 2, the wavefront aberration is increased in proportion to the thickness error of the substrate.

When optical discs are produced on a large scale, it is impossible to accurately maintain uniform thicknesses of substrates of all the optical discs. For this reason, it is necessary to correct the spherical aberration occurring due to the thickness deviation of the substrate of the optical disc in order to adopt an object lens having a high numerical aperture of 0.85 in the BD optical pickup. An example of a method of correcting the spherical aberration is to adjust the distance between a collimating lens and the object lens. However, when a collimating lens driving unit malfunctions while the collimating lens is being moved to adjust the distance between the collimating lens and the object lens, it is impossible to adjust the distance between the collimating lens and the object lens, whereby the spherical aberration is not sufficiency corrected.

### SUMMARY OF THE INVENTION

Therefore, it is an aspect of the invention to release the mechanical locking occurring between a lead screw, which is rotated by a motor, and a moving member, which is movable by the interaction between the moving member and the lead screw.

In accordance with an aspect of the invention, an apparatus includes a motor that is rotatable; a lead screw including a thread part, the lead screw being rotatably coupled to the motor so that the lead screw rotates when the motor rotates; a moving member reciprocatably coupled to the thread part of the lead screw so that the moving member moves in a first direction when the lead screw is rotated in a first rotary direction by the motor, and moves in a second direction opposite to the first direction with the lead screw is rotated in a second rotary direction opposite to the first rotary direction by the motor, wherein if the lead screw is rotated too far in the first rotary direction by the motor, a mechanical locking occurs between the thread part of the lead screw and the moving member; and a control unit that controls a magnitude of electric power supplied to the motor so that when the mechanical locking has occurred between the thread part of the lead screw and the moving member, the motor generates a torque having a magnitude and a direction effective to release the mechanical locking.

In accordance with another aspect of the invention, the apparatus further includes a servo circuit that generates a drive signal to control a torque and a rotating direction of the motor under control of the control unit, and outputs the drive signal to the motor.

In accordance with another aspect of the invention, the servo circuit includes a constant voltage part that outputs a constant voltage; a voltage adjusting circuit, connected to the constant voltage part and responsive to the control unit, that selectively controls the constant voltage outputted from the constant voltage part to be a normal voltage or a raised voltage higher than the normal voltage under the control of the control unit; and a motor driving part that receives the constant voltage outputted from the constant voltage part as controlled by the voltage adjusting circuit, generates the drive signal based on a magnitude of the constant voltage outputted from the constant voltage part as controlled by the voltage adjusting circuit, and outputs the drive signal to the motor; wherein the drive signal causes the motor to generate a torque having a magnitude proportional to the magnitude of the constant voltage outputted from the constant voltage part as controlled by the voltage adjusting circuit.

In accordance with another aspect of the invention, the drive signal includes a first drive signal that drives the motor to rotate the lead screw when the mechanical locking has not occurred, the first drive signal being generated based on a magnitude of the normal voltage; and a second drive signal that drives the motor to rotate the lead screw with a torque having the magnitude and the direction effective to release the mechanical locking when the mechanical locking has occurred, the second drive signal being generated based on a magnitude of the raised voltage.

In accordance with another aspect of the invention, a torque generated by the motor when the motor is driven by the second drive signal is greater than a torque generated by the motor when the motor is driven by the first drive signal; and a rotating direction of the motor when the motor is driven by the second drive signal is opposite to a rotating direction of the motor when the motor is driven by the first drive signal.

In accordance with another aspect of the invention, the constant voltage part includes a voltage output terminal that outputs the constant voltage as controlled by the voltage adjusting unit; an internal current source that generates a constant current; and a current output terminal that outputs the constant current; the voltage adjusting circuit includes a first resistor connected between the first node and the second node; a second resistor connected between the second node and the ground; a third resistor including a first terminal and a second terminal, the first terminal being connected to the second node; and a switch responsive to the control unit and including a third terminal and a fourth terminal, the third terminal being connected to the second terminal of the third resistor and the fourth terminal connected to the ground so that the third resistor and the switch are connected in series between the second node and the ground; and the control unit selectively turns the switch on and off.

In accordance with another aspect of the invention, when the mechanical locking has not occurred between the thread part of the lead screw and the moving member, the control unit turns the switch on to control the constant voltage outputted from the constant voltage part to be the normal voltage, thereby causing the motor driving part to generate and output the first drive signal; and when the mechanical locking has occurred between the thread part of the lead screw and the moving member, the control unit turns the switch off to control the constant voltage outputted from the constant voltage part to be the raised voltage, thereby causing the motor to generate and output the second drive.

In accordance with another aspect of the invention, a magnitude Vcc_on of the normal voltage that is outputted from the constant voltage part when the switch is turned on is expressed by the following equation:

$$Vcc\_on = {V}_{ref} ( 1 + \frac{R 2 ‖ R 3 )}{R 1} ) + Iadj \cdot ( R 2 ‖ R 3 ) \\ wherein \text{:} \\ R 2 ‖ R 3 = \frac{( R 2 \cdot R 3 )}{( R 2 + R 3 )} ;$$

Vref is an internal reference voltage of the constant voltage part;

Iadj is the constant current generated by the internal current source of the constant voltage part;

R1 is a resistance value of the first resistor;

R2 is a resistance value of the second resistor; and

R3 is a resistance value of the third resistor.

In accordance with another aspect of the invention, a magnitude Vcc_off of the raised voltage that is outputted from the constant voltage part when the switch is turned off is expressed by the following equation:

$$Vcc\_off = {V}_{ref} ( 1 + \frac{R 2}{R 1} ) + Iadj \cdot R 2$$

wherein:

Vref is an internal reference voltage of the constant voltage part;

Iadj is the constant current generated by the internal current source of the constant voltage part;

R1 is a resistance value of the first resistor;

R2 is a resistance value of the second resistor; and

R3 is a resistance value of the third resistor.

In accordance with another aspect of the invention, the motor is a step motor; and the control unit controls a rotating direction and a rotating angle of the step motor.

In accordance with another aspect of the invention, the apparatus further includes a nut including a threaded hole; the nut is integrally coupled to the moving member; the moving member includes a lead screw insertion hole provided in a portion of the moving member where the nut is integrally coupled to the moving member so that the lead screw insertion hole is aligned with the threaded hole of the nut; and the lead screw is inserted through the threaded hole of the nut and the lead screw insertion hole so that the thread part of the lead screw engages the threaded hole of the nut.

In accordance with another aspect of the invention, the moving member includes a threaded lead screw insertion hole; and the lead screw is inserted into the threaded lead screw insertion hole so that the thread part of the lead screw engages the threaded lead screw insertion hole.

In accordance with another aspect of the invention, an optical disc drive includes a motor that is rotatable; a lead screw including a thread part, the lead screw being rotatably coupled to the motor so that the lead screw rotates when the motor rotates; a lens; a lens holder having the lens mounted thereon, the lens holder being reciprocatably coupled to the thread part of the lead screw so that the lens holder moves in a first direction when the lead screw is rotated in a first rotary direction by a motor, and moves in a second direction opposite to the first direction when the lead screw is rotated in a second rotary direction opposite to the first rotary direction by the motor, thereby changing a position of the lens mounted on the lens holder, wherein if the lead screw is rotated too far in the first rotary direction, a mechanical locking occurs between the thread part of the lead screw and the lens holder; and a control unit that controls a magnitude of electric power supplied to the motor so that when the mechanical locking has occurred between the thread part of the lead screw and the lens holder, the motor generates a torque having a magnitude and a direction effective to release the mechanical locking.

In accordance with another aspect of the invention, the optical disc drive further includes a servo circuit that generates a drive signal to control a torque and a rotating direction of the motor under control of the control unit, and outputs the drive signal to the motor.

In accordance with another aspect of the invention, the servo circuit includes a constant voltage part that outputs a constant voltage; a voltage adjusting circuit, connected to the constant voltage part and responsive to the control unit, that selectively controls the constant voltage outputted from the constant voltage part to be a normal voltage or a raised voltage higher than the normal voltage under the control of the control unit; and a motor driving part that receives the constant voltage outputted from the constant voltage part as controlled by the voltage adjusting circuit, generates the drive signal based on a magnitude of the constant voltage outputted from the constant voltage as controlled by the voltage adjusting circuit, and outputs the drive signal to the motor; wherein the drive signal causes the motor to generate a torque having a magnitude proportional to the magnitude of the constant voltage outputted from the constant voltage part as controlled by the voltage adjusting circuit.

In accordance with another aspect of the invention, the drive signal includes a first drive signal that drives the motor to rotate the lead screw when the mechanical locking has not occurred, the first drive signal being generated based on a magnitude of the normal voltage; and a second drive signal that drives the motor to rotate the lead screw with the torque having the magnitude and the direction effective to release the mechanical locking when the mechanical locking has occurred, the second drive signal being generated based on a magnitude of the raised voltage.

In accordance with another aspect of the invention, a torque generated by the motor generated when the motor is driven by the second drive signal is greater than a torque generated by the motor when the motor is driven by the first drive signal; and a rotating direction of the motor when the motor is driven by the second drive signal is opposite to a rotating direction of the motor when the motor is driven by the first drive signal.

In accordance with another aspect of the invention, the constant voltage part includes a voltage output terminal that outputs the constant voltage as controlled by the voltage adjusting unit; an internal current source that generates a constant current; and a current output terminal that outputs the constant current; the voltage adjusting circuit includes a first node connected to the voltage output terminal of the constant voltage part; a second node connected to the current output terminal of the current voltage part; a ground; a first resistor connected between the first node and the second node; a second resistor connected between the second node and the ground; a third resistor including a first terminal and a second terminal, the first terminal being connected to the second node; and a switch responsive to the control unit and including a third terminal and a fourth terminal, the third terminal being connected to the second terminal of the third resistor and the fourth terminal being connected to the ground so that the third resistor and the switch are connected in series between the second node and the ground; and the control unit selectively turns the switch on and off.

In accordance with another aspect of the invention, when the mechanical locking has not occurred between the thread part of the lead screw and the lens holder, the control unit turns the switch on to control the constant voltage outputted from the constant voltage part to be the normal voltage, thereby causing motor drive part to generate and output the first drive signal; and when the mechanical locking has occurred between the thread part of the lead screw and the lens holder, the control unit turns the switch off to control the constant voltage outputted from the constant voltage part to be the raised voltage, thereby causing the motor drive part to generate and output the second drive signal.

In accordance with another aspect of the invention, a magnitude Vcc_on of the normal voltage that is outputted from the constant voltage part when the switch is turned on is expressed by the following equation:

$$Vcc\_on = {V}_{ref} ( 1 + \frac{R 2 ‖ R 3 )}{R 1} ) + Iadj \cdot ( R 2 ‖ R 3 ) \\ wherein \text{:} \\ R 2 ‖ R 3 = \frac{( R 2 \cdot R 3 )}{( R 2 + R 3 )} ;$$

Vref is an internal reference voltage of the constant voltage part;

Iadj: is the constant current generated by the internal current source of the constant voltage part;

R1 is a resistance value of the first resistor;

R2 is a resistance value of the second resistor; and

R3 is a resistance value of the third resistor.

In accordance with another aspect of the invention, a magnitude Vcc_off of the raised voltage that is outputted from the constant voltage part when the switch is turned off is expressed by the following equation:

$$Vcc\_off = {V}_{ref} ( 1 + \frac{R 2}{R 1} ) + Iadj \cdot R 2$$

wherein:

Vref internal reference voltage of the constant voltage part;

Iadj is the constant current generated by the internal current source of the constant voltage part;

R1 is a resistance value of the first resistor;

R2 is a resistance value of the second resistor; and

R3 is a resistance value of the third resistor.

In accordance with another aspect of the invention, the lens is a collimating lens that focuses light.

In accordance with another aspect of the invention, the collimating lens is disposed on an optical axis; the optical disc drive further includes an object lens disposed on the optical axis; and the moves the collimating lens relative to the object lens along the optical axis when the lens holder moves in the first direction and the second direction.

In accordance with another aspect of the invention, the motor is a step motor; and the control unit controls a rotating direction and a rotating angle of the step motor.

In accordance with another aspect of the invention, the optical disc drive further includes a nut including a threaded hole; the nut is integrally coupled to the lens holder; the lens holder includes a lead screw insertion hole provided in a portion of the lens holder where the nut is integrally coupled to the lens holder so that the lead screw insertion hole is aligned with the threaded hole of the nut; and the lead screw is inserted through the threaded hole of the nut and the lead screw insertion hole so that the thread part of the lead screw engages the threaded hole of the nut.

In accordance with another aspect of the invention, the lens holder includes a threaded lead screw insertion hole; and the lead screw is inserted into the threaded lead screw insertion hole so that the thread part of the lead screw engages the threaded lead screw insertion hole.

In accordance with another aspect of the invention, there is provided a method of controlling an optical disc drive, the optical disc drive including a motor that is rotatable; a lead screw including a thread part, the lead screw being rotatably coupled to the motor so that the lead screw rotates when the motor rotates; a lens; and a lens holder having the lens mounted thereon, the lens holder being reciprocatably coupled to the thread part of the lead screw so that the lens holder moves in a first direction when the lead screw is rotated in a first rotary direction by the motor, and moves in a second direction opposite to the first direction when the lead screw is rotated in a second rotary direction opposite to the first rotary direction by the motor, thereby changing a position of the lens mounted on the lens holder, wherein if the lead screw is rotated too far in the first rotary direction, a mechanical locking occurs between the thread part of the lead screw and the lens holder; the method including supplying electric power to the motor to drive the motor to rotate the lead screw; monitoring whether the mechanical locking has occurred between the lead screw and the lens holder; and when the mechanical locking has occurred between the thread part of the lead screw and the lens holder, controlling a magnitude of the electric power supplied to the motor so that the motor generates a torque having a magnitude and a direction effective to release the mechanical locking.

In accordance with another aspect of the invention, the method further includes controlling the magnitude of the electric power supplied to the motor so that a torque generated by the motor when the mechanical locking has occurred is greater than a torque generated by the motor when the mechanical locking has not occurred; and controlling a rotating direction of the motor so that a rotating direction of the motor when the mechanical locking has occurred is opposite to a rotating direction of the motor when the mechanical locking has not occurred.

In accordance with another aspect of the invention, the optical disc drive has an optical disc loaded therein; the optical disc loaded in the optical disc drive produces spherical aberration; and the supplying of electric power to the motor to drive the motor to rotate the lead screw includes supplying electric power to the motor to drive the motor to drive the lead screw to move the lens holder to change the position of the lens to correct the spherical aberration of the optical disc loaded in the optical disc drive.

In accordance with another aspect of the invention, the method further includes giving an alarm and interrupting operation of the motor if the mechanical locking is not released by the controlling of a magnitude of the electric power supplied to the motor so that the motor generates a torque having a magnitude and a direction effective to release the mechanical locking.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments, taken in conjunction with the accompanying drawings of which:

FIG. 1 is a view of a section of an optical disc;

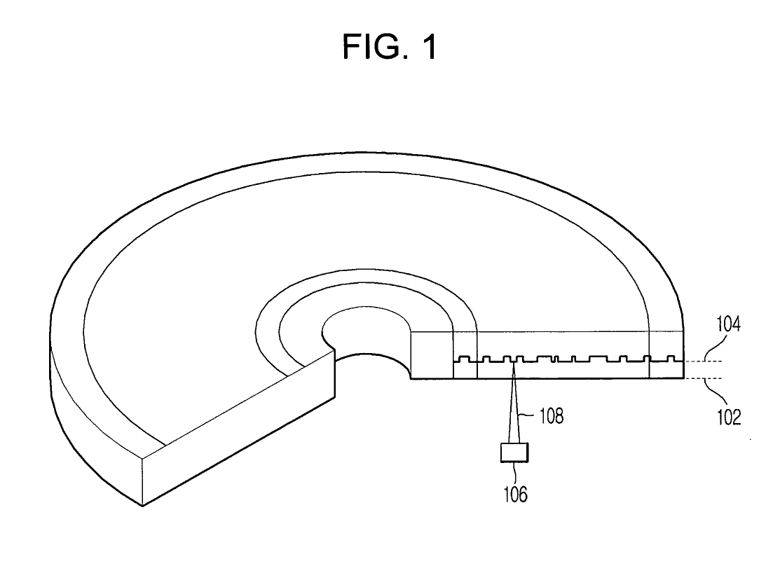

FIG. 2 is a graph of a relation between a thickness error of a substrate of an optical disc and a wavefront aberration of a BD optical pickup including a blue laser light source having a wavelength of 405 nm and an object lens having a numerical aperture of 0.85;

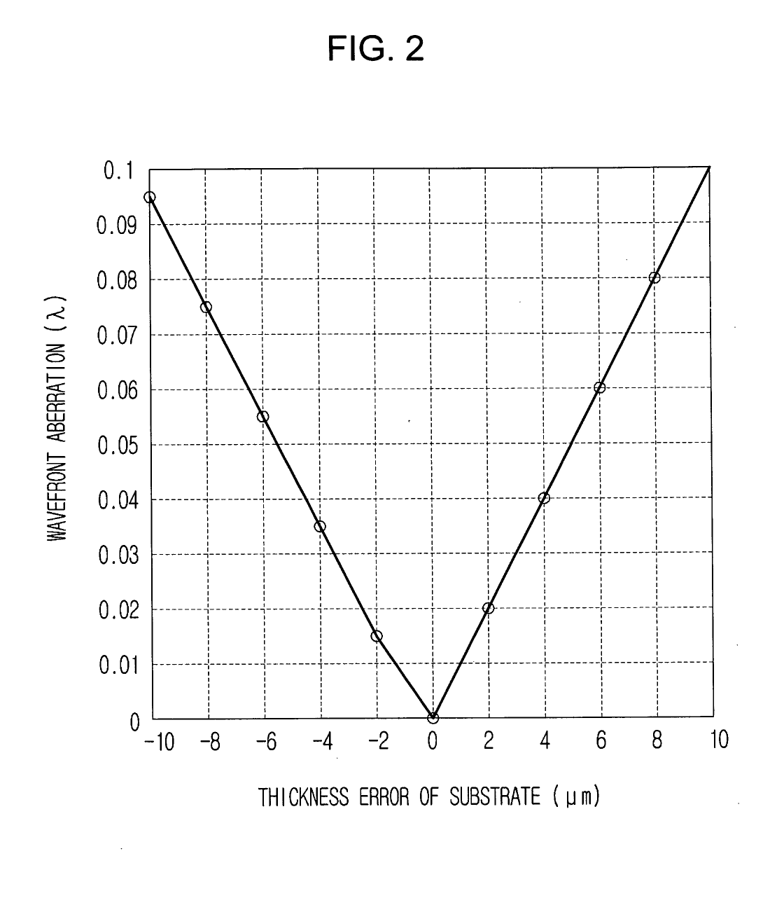

FIG. 3 is a block diagram of an optical disc drive according to an aspect of the invention;

FIG. 4 is a view of the optical system of the optical pickup shown in FIG. 3 according to an aspect of the invention;

FIG. 5A is an exploded perspective view of an example of the collimating lens driving unit of the optical pickup shown in FIG. 4 according to an aspect of the invention;

FIG. 5B is an exploded perspective view of another example of the collimating lens driving unit of the optical pickup shown in FIG. 4 according to an aspect of the invention;

FIG. 6 is a plan view of the collimating lens driving unit shown in FIG. 5A according to an aspect of the invention;

FIG. 7 is a block diagram of a servo circuit for controlling the collimating lens driving unit shown in FIG. 4 according to an aspect of the invention;

FIG. 8 shows an equivalent circuit of a voltage adjusting circuit shown in FIG. 7 when a switch is turned on due to the nonoccurrence of the mechanical locking between a lead screw and a collimating lens holder in the optical pickup according to an aspect of the invention;

FIG. 9 shows an equivalent circuit of the voltage adjusting circuit shown in FIG. 7 when the switch is turned off due to the occurrence of the mechanical locking between the lead screw and the collimating lens holder in the optical pickup according to an aspect of the invention; and

FIG. 10 is a flow chart of a method of controlling the optical disc drive according to an aspect of the invention.

### DETAILED DESCRIPTION OF THE EMBODIMENTS

Reference will now be made in detail to embodiment of the invention, examples of which are shown in the accompanying drawings, wherein like reference numerals refer to like elements throughout. The embodiments are described below to explain the invention by referring to the figures.

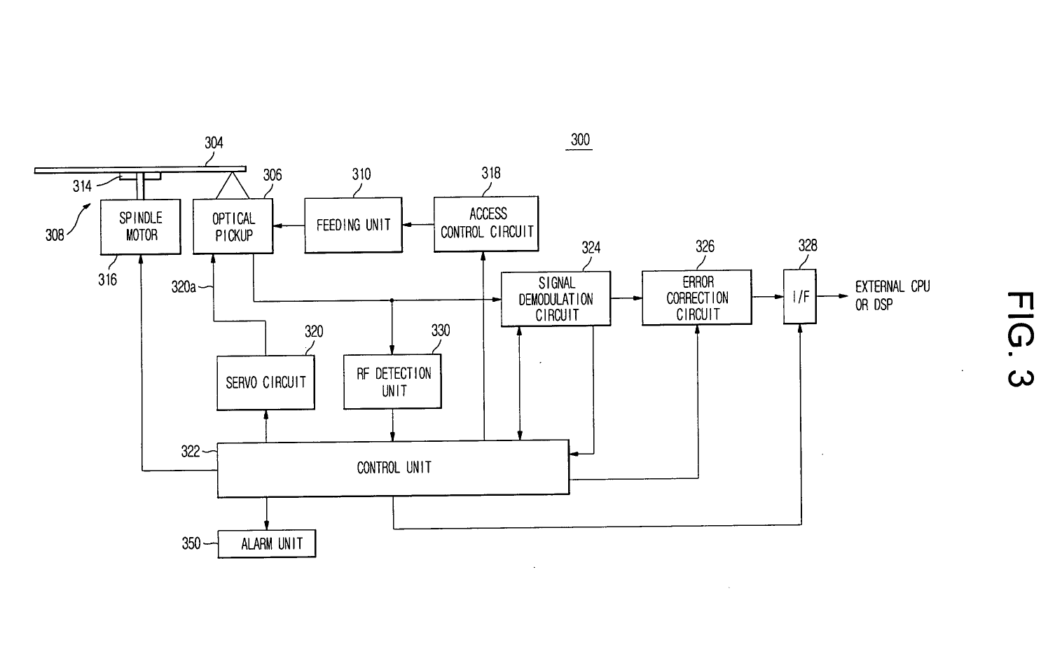

FIG. 3 is a block diagram of an optical disc drive 300 according to an aspect of the invention. As shown in FIG. 3, the optical disc drive 300 records data on an optical disc 304 or reproduces data recorded on the optical disc 304. The optical disc 304 includes a CD, a DVD, a BD, and any other optical discs.

The optical disc drive 300 includes an optical pickup 306 for recording/reproducing data, a disc rotating unit 308 for rotating the optical disc 304, a feeding unit 310 for moving the optical pickup 306 in the radial direction of the optical disc 304, and a control unit 322 for controlling overall operation of the optical disc drive 300.

The disc rotating unit 308 includes a disc table 314, on which the optical disc 304 is placed, and a spindle motor 316 for rotating the disc table 314. The feeding unit 310 includes a support base (not shown) for supporting the optical pickup 306, and a main shaft and a sub shaft (not shown) for allowing the support base to be moved.

The control unit 322 serves to control an access control circuit 318 for driving the feeding unit 310 so that the optical pickup 306 can be moved in the radial direction of the optical disc 304 and a servo circuit 320 for driving a two-axis actuator and a collimating lens of the optical pickup 306. The optical pickup 306 is driven based on a drive signal 320a outputted from the servo circuit 320. Also, the control unit 322 serves to control a signal demodulation circuit 324 for demodulating a radio frequency (RF) signal outputted from the optical pickup 306, an error correction circuit 326 for correcting the error of the demodulated signal, and an interface circuit 328 for outputting the error-corrected signal to an external central processing unit (CPU) or an external digital signal processor (DSP). In this way, the control unit 322 is involved in processing of the data signal reproduced from the optical pickup 306. In the case that the optical disc drive 300 is a product that can not only reproduce but also record data, the control unit 322 is also involved in processing of a data signal inputted from the outside and recorded on the optical disc 304 through the optical pickup 306.

Also, an RF detection unit 330 serves to detect the level and the jitter of the RF signal outputted from the optical pickup 306 and to provide the detected information to the control unit 322. The control unit 322 controls the position of the collimating lens to correct the spherical aberration in the optical pickup 306 based on the level information and the jitter information of the RF signal detected by the RF detecting unit 330. Specifically, the control unit 322 determines that the spherical aberration is minimum at the distance between the collimating lens and the object lens when the level of the RF signal is maximum or when the jitter of the RF signal is minimum while the collimating lens is moved to adjust the distance between the collimating lens and the object lens, and performs the recording/reproduction of the data with respect to the optical disc 304 while maintaining the above-described distance between the collimating lens and the object lens.

The level of the RF signal is maximum when the spherical aberration is minimum. On the other hand, the jitter of the RF signal is minimum when the spherical aberration is minimum.

In the optical disc drive 300 with the above-stated construction, the disc table 314, on which the optical disc 304 is placed, is rotated by the spindle motor 316, and the feeding unit 310 is controlled by the control signal of the access control circuit 318 so that the optical pickup 306 can be moved to a target track position on the optical disc 304, whereby data is recorded on the optical disc 304, or the recorded data is reproduced from the optical disc 304. To the control unit 322 is connected an alarm unit 350. The control unit 322 controls the alarm unit 350 to sound an alarm, when the optical disc drive 300 is abnormally operated, or has mechanical or electrical problems, so that a user or a high-ranking control unit can deal with the trouble.

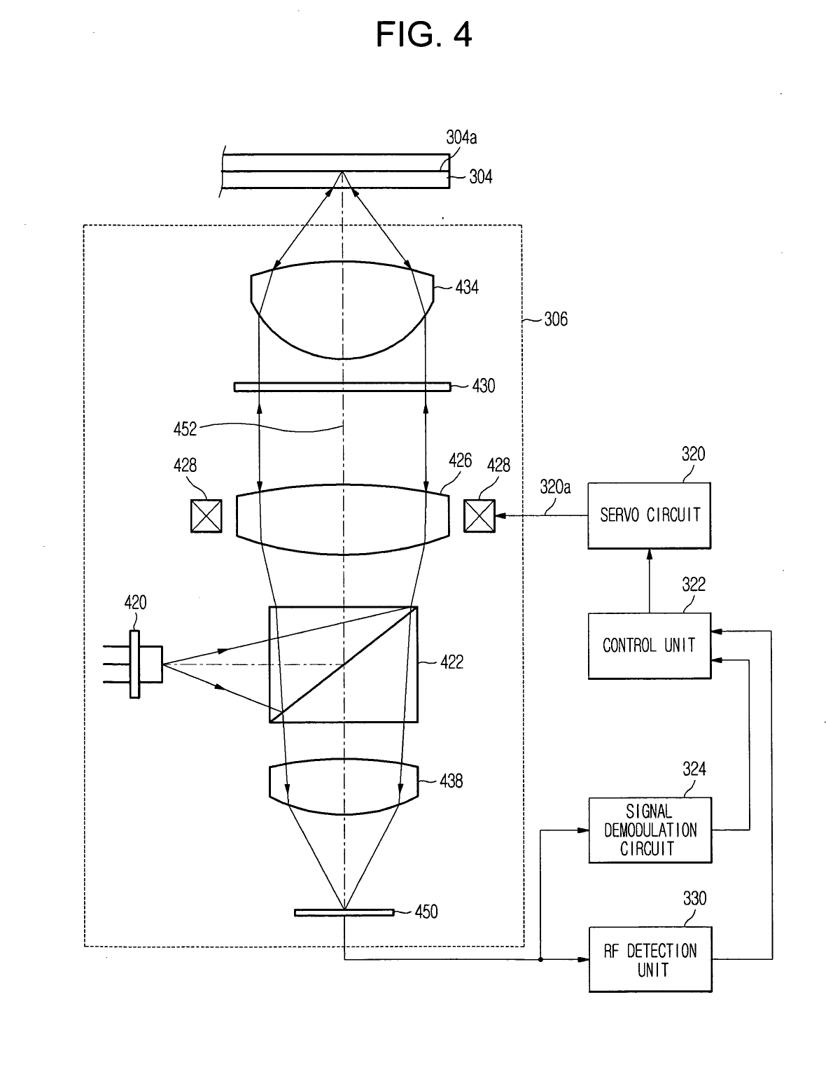

FIG. 4 is a view of the optical system of the optical pickup 306 shown in FIG. 3. As shown in FIG. 4, the optical pick up 306 includes a light source 420 for generating and emitting a laser beam, a polarizing beam splitter 422 for transmitting and reflecting incident light depending upon the polarization thereof, a ¼ wavelength plate 430 for converting the polarization of the incident light, an object lens 434 for focusing the incident light to form a light spot on a data recording surface 304a of the optical disc 304, and a light detector 450 for receiving the light reflected from the data recording surface 304a of the optical disc 304. An RF signal generated by the light detection of the light detector 450 is inputted to the signal demodulation circuit 324 and the RF detection unit 330. Between the polarizing beam splitter 422 and the ¼ wavelength plate 430 is disposed a collimating lens 426 for focusing the light reflected from the polarizing beam splitter 422 and entering the object lens 434. Between the polarizing beam splitter 422 and the light detector 450 is disposed a condensing lens 438. Also, a collimating lens driving unit 428 is provided for moving the collimating lens 426 along an optical axis 452 to adjust the distance between the object lens 434 and the collimating lens 426. The control unit 322 controls the collimating lens driving unit 428 through the servo circuit 320 to move the collimating lens 426 along the optical axis 452 for adjusting the distance between the collimating lens 426 and the object lens 434 to minimize the spherical aberration. The collimating lens driving unit 428 is driven based on the drive signal 320a outputted from the servo circuit 320. As occasion demands, the invention may also be applied to drive the object lens 434 or the condensing lens 438 as well as the collimating lens 426.

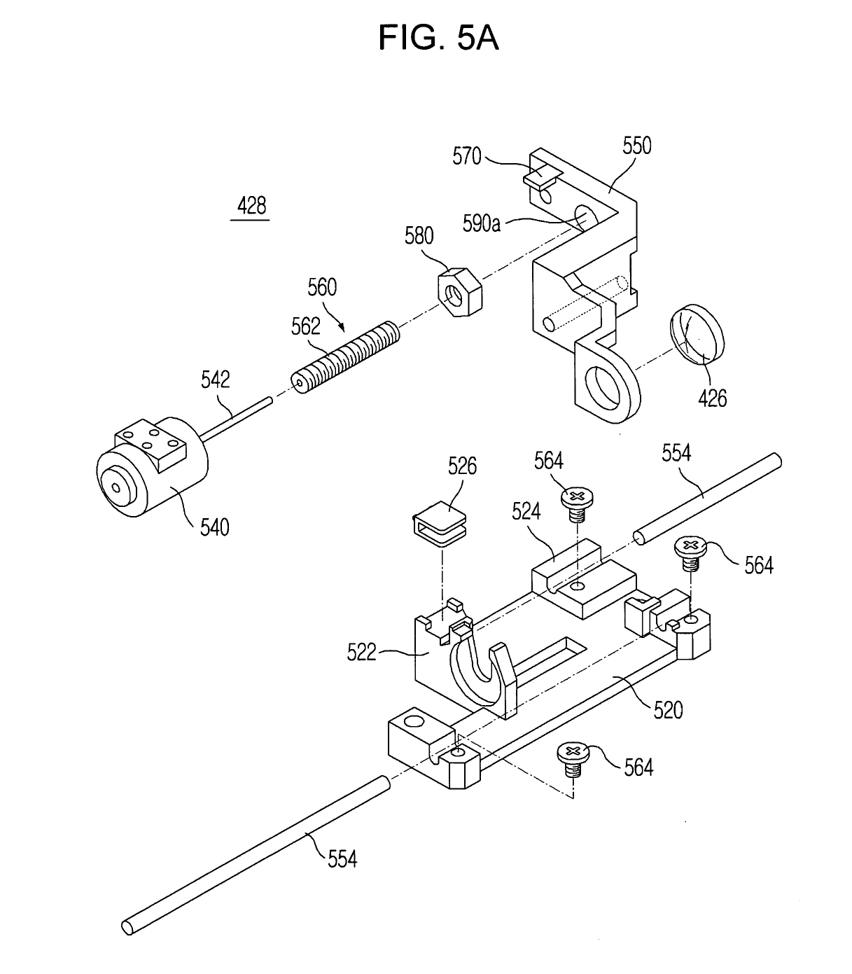

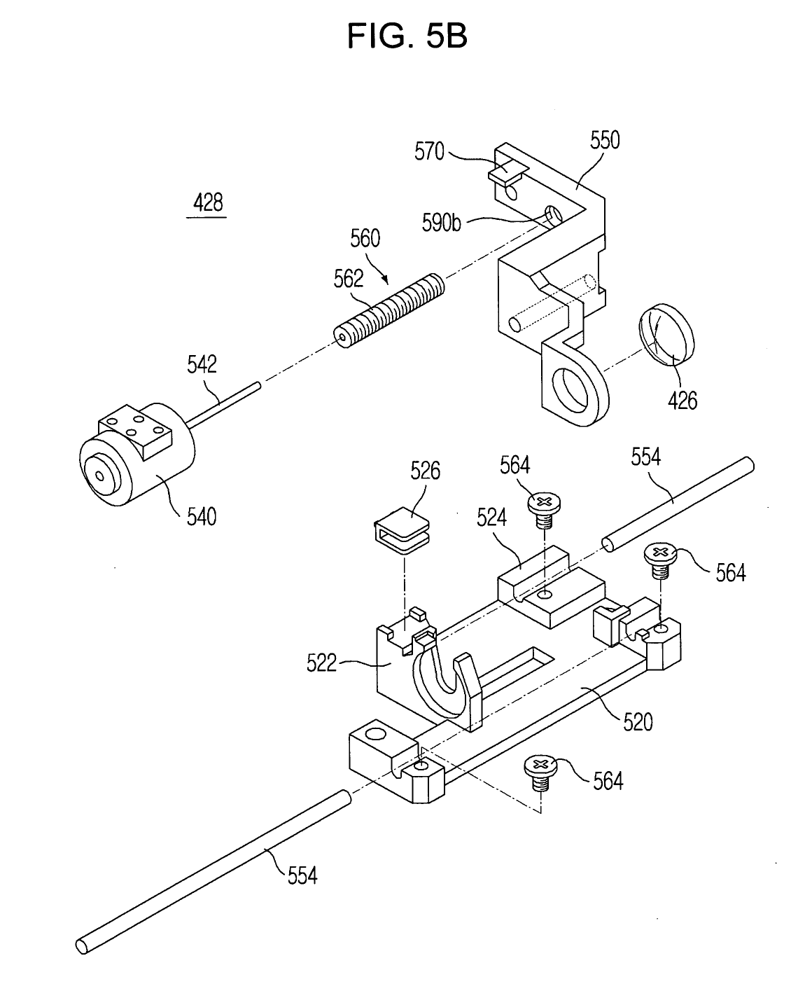

FIG. 5A is an exploded perspective view of an example of the collimating lens driving unit of the optical pickup 306 shown in FIG. 4. As shown in FIG. 5A, the collimating lens driving unit 428 includes a base 520, to which various parts are mounted, a step motor 540 mounted to the base 520, a lead screw 560 coupled to a rotary shaft 542 of the step motor 540, a nut 580, through which the lead screw is inserted, and a collimating lens holder 550, which is a moving member integrally coupled with the nut 580 so that the moving member can be moved together with the nut 580. The collimating lens holder 550 is provided at a predetermined position thereof where the nut 580 is coupled with a lead screw insertion hole 590a. The lead screw 560 is inserted through the nut 580 and the lead screw insertion hole 590a in turn.

At one side of the base 520 is disposed a motor support part 522 for supporting one end of the step motor 540. At the other side of the base 520 is disposed a protrusion 524 for restricting unnecessary movement of the collimating lens holder 550. As a result, a space for allowing the collimating lens holder 550 to freely move without interference with the base 520 is provided between the motor support part 522 and the protrusion 524. Also, two guide shafts 554 are fixed to the base 520 by means of three bolts 564 so that the guide shafts 554 are arranged in parallel with each other. The guide shafts 554 guide the rectilinear movement of the collimating lens holder 550. The rectilinear movement direction of the collimating lens holder 550 is parallel with the longitudinal direction of the guide shafts 554.

One end of the step motor 540 is located at the motor support part 522 of the base, and the rotary shaft 542 of the step motor 540 is securely fitted in the lead screw 560 having a thread part 562. Consequently, as the step motor 540 is rotated, the lead screw 560 is also rotated. Also, the nut 580 is fitted on the outer circumference of the lead screw 560. The nut 580 is fixed to the collimating lens holder 550 with the result that the nut 580 is not rotated when the lead screw 560 is rotated. Consequently, when the lead screw 560 is rotated due to the rotation of the step motor 540, the nut 580 interacts with the thread part 562 of the lead screw 560 so that the nut 580 is reciprocated in opposite directions depending upon the rotating direction of the lead screw 560, i.e., in first and second directions. Since the nut 580 and the collimating lens holder 550 are fixed to each other, the nut 580 and the collimating lens holder 550 are moved as one body. The movement direction of the nut 580 and the collimating lens holder 550 is parallel with the longitudinal direction of the guide shafts 554, as described above.

The collimating lens 426 is mounted at one end of the collimating lens holder 550. At the other end of the collimating lens holder 550 is disposed a detection part 570, which interacts with an optical sensor 526 mounted to the base 520 for setting the reference position of the collimating lens holder 550. Specifically, if the current position of the collimating lens holder 550 is not known when the collimating lens holder 550 is to be moved, it is not possible to decide the correct movement distance. Consequently, the collimating lens holder 550 is moved toward the step motor 540 so that the position of the collimating lens holder 550 can be confirmed by the optical sensor 526, and then the movement distance of the collimating lens holder 550 is decided based upon the confirmed position of the collimating lens holder 550, which serves as the reference position of the collimating lens holder 550.

The detection of the position of the collimating lens holder 550 using the optical sensor 526 is also used to confirm the mechanical locking of the lead screw 560. Specifically, when the electric power supplied to the step motor 540 is excessively increased due to a circuit defect of the servo circuit 320 that drives the step motor 540 or a software error of the control unit 322, and therefore, the step motor 540 is rotated more than necessary, even after the collimating lens holder 550 is moved toward the motor support part 522 until the collimating lens holder 550 reaches the reference position, it is determined that the mechanical locking of the lead screw 560 occurs. Consequently, a controlling operation to release the mechanical locking is performed.

FIG. 5B is an exploded perspective view of another example of the collimating lens driving unit of the optical pickup 306 shown in FIG. 4. As shown in FIG. 5B, a thread part, which corresponds to the thread part 562 of the lead screw 560, is formed at the inner circumferential surface of a lead screw insertion hole 590b formed in the collimating lens holder 550. In this case, the collimating lens holder 550 serves as a nut, and therefore, no additional nut is necessary.

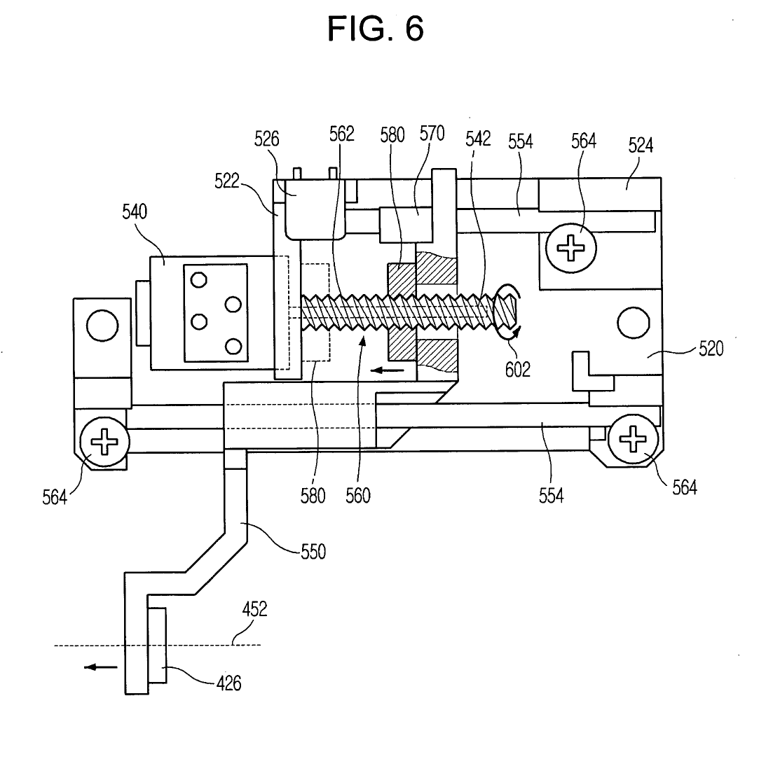

FIG. 6 is a plan view of the collimating lens driving unit shown in FIG. 5A. As shown in FIG. 6, when the step motor 540 rotates the lead screw 560 in the clockwise direction (see the rotating direction indicated by reference numeral 602 in FIG. 6) in the case that the collimating lens holder 550 is seen from the position of the step motor 540, the collimating lens holder 550 is moved toward the step motor 540, and therefore, the collimating lens 426 mounted to the collimating lens holder 550 is moved along the optical axis 452. When the collimating lens holder 550 is moved a predetermined distance toward the step motor 540, and therefore, the detection part 570 of the collimating lens holder 550 is detected by the optical sensor 526, the rotation of the step motor 540 is stopped (see the nut 580 indicated by the dotted line in FIG. 6).

According to circumstances, however, the optical sensor 526 may not be operated or may be abnormally operated, and therefore, the step motor 540 may be continuously rotated without stopping. Also, when the electric power supplied to the step motor 540 is excessively increased due to a circuit defect of the servo circuit 320 that drives the step motor 540 or a software error of the control unit 322, and therefore, the step motor 540 is rotated in the clockwise direction more than necessary, the nut 580 (in the case of FIG. 5B, the collimating lens holder 550) is brought into tight contact with the motor support part 522, and therefore, “mechanical locking” occurs between the lead screw 560 and the collimating lens holder 550. The “mechanical locking” means that the lead screw 560 and the collimating lens holder 550 (specifically, the nut 580 or the lead screw insertion hole 590b) are tightly engaged with each other, and therefore, the tight engagement is not released unless very large torque is generated in the direction opposite to the tight engagement direction, whereby further rotation of the lead screw 560 is impossible. When the mechanical locking occurs strongly between the lead screw 560 and the collimating lens holder 550, the step motor 540 cannot generate reverse-direction torque having a magnitude sufficient to release the mechanical locking by the drive voltage having a magnitude supplied to the step motor 540 in a normal state. As a result, the mechanical locking between the lead screw 560 and the collimating lens holder 550 is not released. When the mechanical locking between the lead screw 560 and the collimating lens holder 550 is not released as described above, the collimating lens holder 550 cannot be moved along the optical axis 452, and therefore, the correction of the spherical aberration through the adjustment of the distance between the object lens 434 and the collimating lens 426 is not accomplished.

Consequently, when the mechanical locking occurs between the lead screw 560 and the collimating lens holder 550, it is preferable for the step motor 540 to generate reverse-direction torque having a magnitude sufficient to release the mechanical locking between the lead screw 560 and the collimating lens holder 550, whereby the mechanical locking is released, and therefore, the correction of the spherical aberration is accomplished.

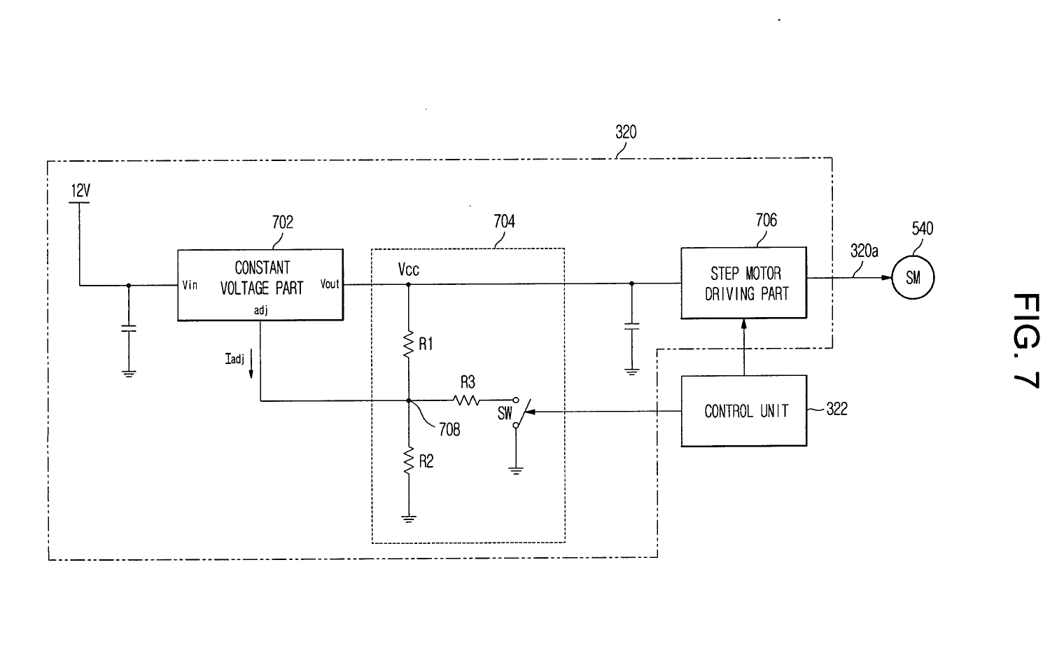

FIG. 7 is a block diagram of a servo circuit for controlling the step motor of the collimating lens driving unit shown in FIG. 4. As shown in FIG. 7, the servo circuit 320, which controls the step motor 540 of the collimating lens driving unit 428, includes a constant voltage part 702, a voltage adjusting circuit 704, and a step motor driving part 706.

The constant voltage part 702 converts a DC input voltage of 12V, which is inputted through an input terminal Vin from the outside, into a stable DC output voltage that is outputted through an output terminal Vout to a node Vcc and is controlled by the voltage adjusting circuit 704. However, the invention is not limited to a DC input voltage of 12V, and other DC input voltages can be used. The constant voltage part 702 may be implemented by a commercially available unit such as an LM317 3-terminal adjustable regulator or any other suitable commercially available unit. The voltage adjusting circuit 704 maintains the voltage of the Vcc node at 3.3V, which is a driving voltage of the step motor 540, during a normal operating mode, or raises the voltage of the Vcc node to 6.72V, which is higher than 3.3V, during a mechanical locking releasing mode. However, the invention is not limited to 3.3V and 6.72V, and other voltages may be used. The selection of the voltage of the Vcc node is controlled by the control unit 322. During the normal operating mode, the control unit 322 controls the voltage adjusting circuit 704 to maintain the voltage of the Vcc node at 3.3V. When the mechanical locking occurs between the lead screw 560 and the collimating lens holder 550, and therefore, the collimating lens holder 550 cannot be moved along the optical axis 452, the control unit 322 controls the voltage adjusting circuit 704 to operate in the mechanical releasing mode and raise the voltage of the Vcc node to 6.72V so that an increased drive current corresponding to the raised voltage of the Vcc node is supplied to the step motor 540. Also, during the mechanical locking releasing mode, the control unit 322 controls the step motor 540 to be rotated in the counterclockwise direction, which is opposite to the clockwise direction in which the step motor 540 was being rotated when the mechanical locking occurred, so that the step motor 540 generates reverse-direction torque having a magnitude sufficient to release the mechanical locking between the lead screw 560 and the collimating lens holder 550.

The voltage adjusting circuit 704 is constructed as follows. Between the output terminal Vout of the constant voltage part 702 and a ground are connected a first resistor R1 and a second resistor R2 in series. Between a node 708, at which the first resistor R1 and a second resistor R2 are connected with each other, and the ground are connected a third resistor R3 and a switch SW in series. Specifically, the third resistor R3 and the switch SW, which are connected in series with each other, are connected in parallel with the second resistor R2.

A current limit threshold adjustment terminal (hereinafter, referred to as an “adj terminal”) of the constant voltage part 702 is connected to an internal current source of the constant voltage part 702 that generates a constant current. The amount of the constant current generated by the internal current source is the amount of reference current used to determine whether overcurrent occurs or not. The amount of the constant current generated the internal current source may be changed depending upon the specification of the constant voltage part 702. The constant current generated by the internal current source is outputted from the adj terminal of the constant voltage part 702, as adj current Iadj and is supplied to the node 708 between the first resistor R1 and the second resistor R2.

The on/off of the switch SW of the voltage adjusting circuit 704 is controlled by the control unit 322. When the mechanical locking does not occur between the lead screw 560 and the collimating lens holder 550, and therefore, the collimating lens 426 can be normally moved along the optical axis 452, the control unit 322 turns the switch SW on. On the other hand, when the mechanical locking occurs between the lead screw 560 and the collimating lens holder 550, and therefore, it is determined that the correction of the spherical aberration through the adjustment of the distance between the object lens 434 and the collimating lens 426 is not accomplished, the control unit 322 turns the switch SW off. Specifically, when the mechanical locking does not occur between the lead screw 560 and the collimating lens holder 550, and therefore, the switch SW is turned on, the second resistor R2 and the third resistor R3 are connected in parallel With each other. As a result, the resistance value between the node 708 and the ground is decreased because the resistance value of the parallel connection of the second resistor R2 and the third resistor R3 is less than the resistance value of the second resistor R2, and therefore, the voltage of the Vcc node is also decreased. On the other hand, when the mechanical locking occurs between the lead screw 560 and the collimating lens holder 550, and therefore, the switch SW is turned off, the third resistor is no longer connected in parallel with the second resistor R2, and it is as if the third resistor R3 were not present. As a result, the voltage of the Vcc node is increased because the resistance value between the node 708 and the ground is the resistance value of the second resistor R2, which is higher than the resistance value of the parallel connection of the second resistor R2 and the third resistor R3 that is produced when the switch SW is turned on.

The drive signal 320a outputted from the step motor driving part 706 has different driving characteristics depending upon whether the mechanical locking has occurred or not. Specifically, the drive signal 320a includes a first drive signal 320a for rotating the lead screw 560 when the mechanical locking has not occurred and a second drive signal 320a for rotating the lead screw 560 with a magnitude sufficient to release the mechanical locking and in the direction to release the mechanical locking when the mechanical locking has occurred. When the constant voltage is inputted to the step motor driving part 706, the step motor driving part 706 outputs the first drive signal 320a, and, when the raised voltage is inputted to the step motor driving part 706, the step motor driving part 706 outputs the second drive signal 320a. Also, the torque of the step motor 540 generated based upon the second drive signal 320a is greater that that of the step motor 540 generated based upon the first drive signal 320a. Furthermore, the rotating directions of the step motor 540 rotated based upon the first drive signal 320a and the second drive signal 320a are opposite to each other. Consequently, the mechanical locking between the lead screw 560 and the collimating lens holder 550 may be released by the second drive signal 320a.

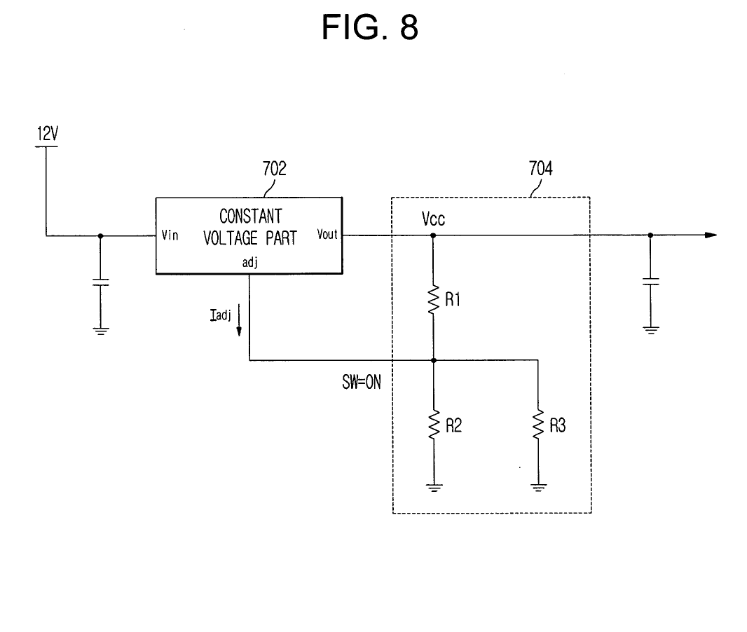

FIG. 8 shows an equivalent circuit of the voltage adjusting circuit 704 when the switch SW is turned on due to the nonoccurrence of the mechanical locking between the lead screw 560 and the collimating lens holder 550 in the optical pickup 306 according to an aspect of the invention. As shown in FIG. 8, when the switch SW is turned on due to the nonoccurrence of the mechanical locking between the lead screw 560 and the collimating lens holder 550, the second resistor R2 and the third resistor R3 are connected in parallel with each other. At this time, the voltage of the Vcc node Vcc_on is expressed by the following equation (3):

$$Vcc\_on = {V}_{ref} ( 1 + \frac{R 2 ‖ R 3 )}{R 1} ) + Iadj \cdot ( R 2 ‖ R 3 ) \\ wherein \text{:} \\ R 2 ‖ R 3 = \frac{( R 2 \cdot R 3 )}{( R 2 + R 3 )} \qquad ( 3 )$$

Vref is an internal reference voltage of the constant voltage part 702;

Iadj is the constant current generated by the internal current source of the constant voltage part 702;

R1 is a resistance value of the first resistor R1;

R2 is a resistance value of the second resistor R2; and

R3 is a resistance value of the third resistor R3

When Vin=12V, Vref=1.25V, Iadj=50 μA, R1=560Ω, R2=2.4 kΩ, and R3=1.5 kΩ, Vcc_on becomes 3.3V, which is identical to the result of the calculation of the following equation (4) when truncated to one decimal place:

$$Vcc\_on = 1.25 ( 1 + \frac{923}{560} ) + ( 50 \cdot {10}^{- 6} ) \cdot ( 923 ) = 3.3 V \qquad ( 4 )$$

Among the above variables, Vin, Vref, and Iadj are known values that can be obtained from a data sheet of the constant voltage part 702. However, the invention is not limited to Vin=12V, Vref=1.25V, and Iadj=50 μA, and any other suitable values may be used depending on the particular constant voltage part 702 being used. Furthermore, the invention is not limited to R1=560Ω, R2=2.4 kΩ, and R3=1.5 kΩ, and other any other suitable values that will produce a desired voltage Vcc may be used.

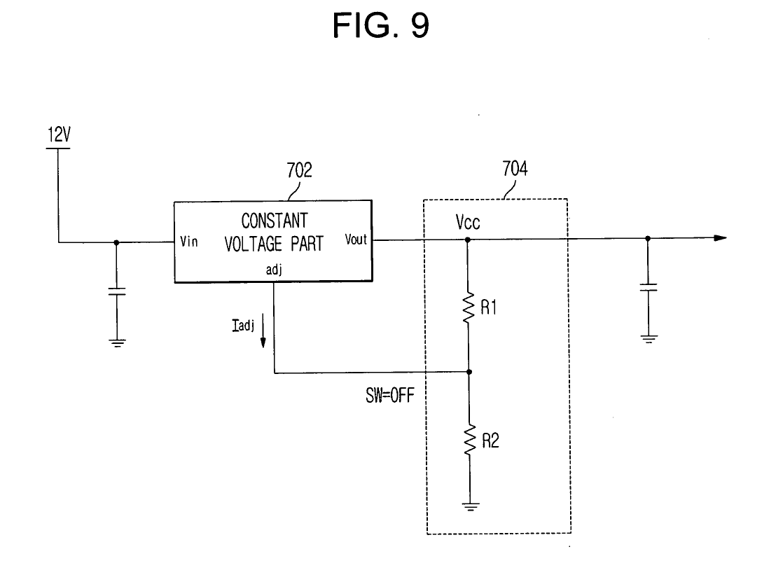

FIG. 9 shows an equivalent circuit of the voltage adjusting circuit 704 when the switch is turned off due to the occurrence of the mechanical locking between the lead screw 560 and the collimating lens holder 550 in the optical pickup 306 according to an aspect of the invention. As shown in FIG. 9, when the switch SW is turned off due to the occurrence of the mechanical locking between the lead screw 560 and the collimating lens holder 550, the third resistor R3 does not affect the circuit. At this time, the voltage of the Vcc node Vcc_off is expressed by the following equation (5):

$$Vcc\_off = {V}_{ref} ( 1 + \frac{R 2}{R 1} ) + Iadj \cdot R 2 \qquad 5 )$$

When Vin=12V, Vref=1.25V, Iadj=50 μA, R1=560Ω, and R2=2.4 kΩ, Vcc_on becomes 6.72V, which is identical to the result of the calculation of the following equation (6) when truncated to two decimal places:

$$Vcc\_off = 1.25 ( 1 + \frac{2.4 \cdot {10}^{3}}{560} ) + ( 50 \cdot {10}^{- 6} ) \cdot ( 2.4 \cdot {10}^{3} ) = 6.72 V \qquad ( 6 )$$

That is, when the switch SW is turned on due to the nonoccurrence of the mechanical locking between the lead screw 560 and the collimating lens holder 550, a voltage of 3.3V, which is a magnitude sufficient to drive the lead screw 560, which is not mechanically locked with the collimating lens holder 550, is supplied to the step motor driving part 706. On the other hand, when the lead screw 560 cannot be driven with the voltage of 3.3V due to the occurrence of the mechanical locking between the lead screw 560 and the collimating lens holder 550, and therefore, the switch SW is turned off, a voltage of 6.72V, which is approximately twice that of 3.3V, is supplied to the step motor driving part 706.

As described above, when the mechanical locking occurs between the lead screw 560 and the collimating lens holder 550, the voltage of 6.72V, which is greater than the voltage of 3.3V, is supplied to the step motor 540 so that the collimating lens holder 550 can be moved, and the step motor 540 is rotated in the direction opposite to the rotating direction in which the mechanical locking has occurred. As a result, the mechanical locking between the lead screw 560 and the collimating lens holder 550 is released, and therefore, the smooth rotation of the lead screw 560 is possible.

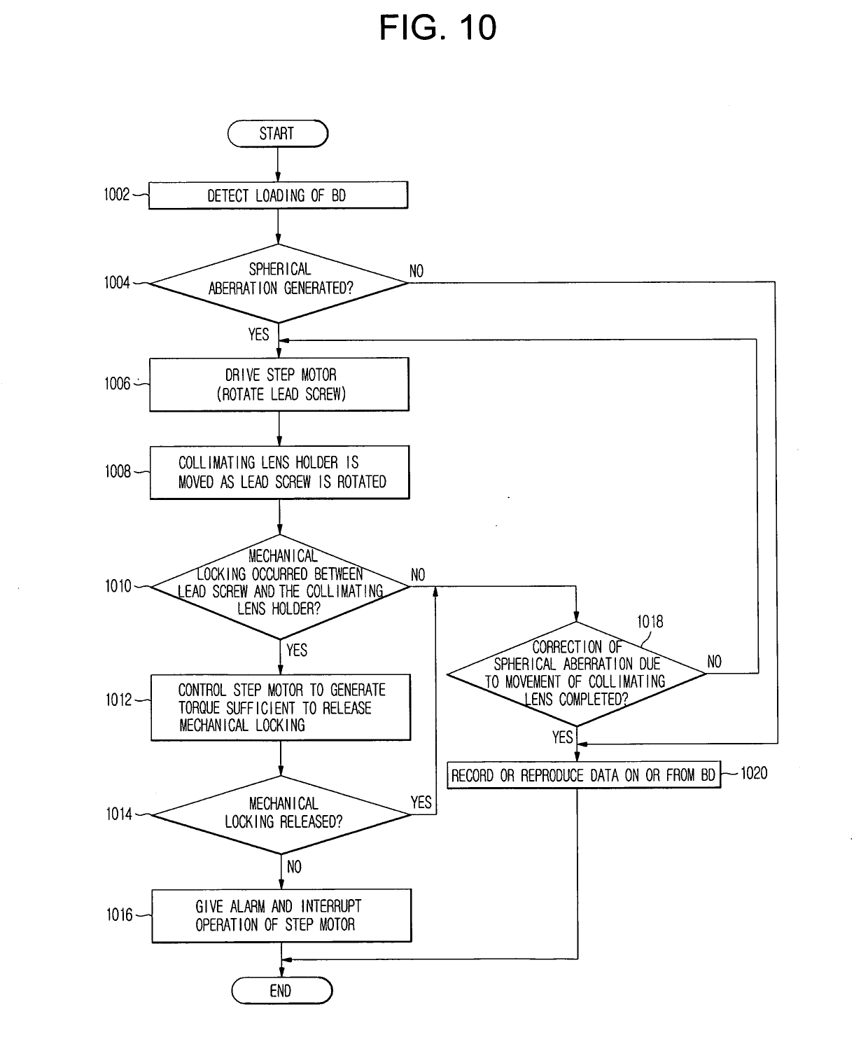

FIG. 10 is a flow chart of a method of controlling the optical disc drive according to an aspect of the invention. As shown in FIG. 10, the control unit 322 detects whether a high-density optical disc, i.e., a Blu-ray disc (BD), has been loaded on a tray (not shown) of the optical disc drive 300 (block 1002). When it is detected that the BD has been loaded on the tray, the control unit 322 confirms whether spherical aberration is generated at the optical pickup 306 due to the nonuniformity of the thickness between the light incidence surface of the loaded BD and the data recording layer (block 1004). When the spherical aberration is generated, and therefore, it is determined that the correction of the spherical aberration is needed (“yes” of block 1004), the control unit 322 drives the step motor 540 to correct the spherical aberration through the adjustment of the distance between the object lens 434 and the collimating lens 426, whereby the lead screw 560 is rotated (block 1006). As the lead screw 560 is rotated, the collimating lens holder 550 is moved along the optical axis 452 such that the collimating lens holder 550 is moved away from the object lens 434 or is moved toward the object lens 434 (block 1008).

Subsequently, the control unit 322 monitors whether the step motor 540 is excessively rotated more than necessary at the position where the collimating lens holder 550 maximally approaches the step motor 540, and therefore, the mechanical locking has occurred between lead screw 560 and the collimating lens holder 550 (block 1010). When the mechanical locking has occurred (“yes” of 1010), the control unit 322 controls the step motor 540 to generate torque having a magnitude sufficient to release the mechanical locking between the lead screw 560 and the collimating lens holder 550 (block 1012). When the mechanical locking is still not released even though the control operation to release the mechanical locking has been carried out (“no” of 1014), the control unit 322 gives an alarm to inform that the optical disc drive has malfunctioned, and interrupts the operation of the step motor 540 (block 1016).

When the mechanical locking has not occurred (“no” of 1010), or when the mechanical locking is released through the above-described control even though the mechanical locking has occurred (“yes” of 1014), the control unit 322 confirms whether the correction of the spherical aberration due to the movement of the collimating lens 426 has been completed (block 1018). When the correction of the spherical aberration has not been sufficiently accomplished (“no” of 1018), the procedure is returned to the step motor driving operation 1006 so that the control of the step motor 540 can be continuously carried out. On the other hand, when the correction of the spherical aberration has been sufficiently accomplished (“yes” of 1018), the recording/reproduction of data on/from the BD is carried out (block 1020).

As apparent from the above description, an aspect of the invention provides an effect in that, when the mechanical locking has occurred between the lead screw, which is rotated by the motor, and the moving member, which is moved by the interaction between the moving member and the lead screw, the motor is controlled so that larger torque is generated in the direction opposite to the mechanical locking direction, whereby the mechanical locking is released.

When the spherical aberration is corrected through the adjustment of the distance between the collimating lens and the object lens in the optical disc drive that records/reproduces data on/from the high-density optical disc, such as the BD, the mechanical locking is released according to an aspect of the invention, whereby the correction of the spherical aberration through the driving of the collimating lens is smoothly accomplished. In consideration of the fact that the correction of the spherical aberration is very important in the recording/reproduction of the data on/from the high-density optical disc, such as the BD, the above-mentioned effect is very useful in that the recording/reproduction of the data on/from the high-density optical disc is smoothly accomplished.

Although several embodiments of the invention have been shown and described, it would be appreciated by those skilled in the art that changes may be made in these embodiments without departing from the principles and spirit of the invention, the scope of which is defined in the claims and their equivalents.

1. An apparatus comprising:
a motor that is rotatable;
a lead screw comprising a thread part, the lead screw being rotatably coupled to the motor so that the lead screw rotates when the motor rotates;
a moving member reciprocatably coupled to the thread part of the lead screw so that the moving member moves in a first direction when the lead screw is rotated in a first rotary direction by the motor, and moves in a second direction opposite to the first direction with the lead screw is rotated in a second rotary direction opposite to the first rotary direction by the motor, wherein if the lead screw is rotated too far in the first rotary direction by the motor, a mechanical locking occurs between the thread part of the lead screw and the moving member; and
a control unit that controls a magnitude of electric power supplied to the motor so that when the mechanical locking has occurred between the thread part of the lead screw and the moving member, the motor generates a torque having a magnitude and a direction effective to release the mechanical locking.

2. The apparatus of claim 1, further comprising a servo circuit that generates a drive signal to control a torque and a rotating direction of the motor under control of the control unit, and outputs the drive signal to the motor.

3. The apparatus of claim 2, wherein the servo circuit comprises:
a constant voltage part that outputs a constant voltage;
a voltage adjusting circuit, connected to the constant voltage part and responsive to the control unit, that selectively controls the constant voltage outputted from the constant voltage part to be a normal voltage or a raised voltage higher than the normal voltage under the control of the control unit; and
a motor driving part that receives the constant voltage outputted from the constant voltage part as controlled by the voltage adjusting circuit, generates the drive signal based on a magnitude of the constant voltage outputted from the constant voltage part as controlled by the voltage adjusting circuit, and outputs the drive signal to the motor;
wherein the drive signal causes the motor to generate a torque having a magnitude proportional to the magnitude of the constant voltage outputted from the constant voltage part as controlled by the voltage adjusting circuit.

4. The apparatus of claim 3, wherein the drive signal comprises:
a first drive signal that drives the motor to rotate the lead screw when the mechanical locking has not occurred, the first drive signal being generated based on a magnitude of the normal voltage; and
a second drive signal that drives the motor to rotate the lead screw with the torque having the magnitude and the direction effective to release the mechanical locking when the mechanical locking has occurred, the second drive signal being generated based on a magnitude of the raised voltage.

5. The apparatus of claim 4, wherein a torque generated by the motor when the motor is driven by the second drive signal is greater than a torque generated by the motor when the motor is driven by the first drive signal; and
wherein a rotating direction of the motor when the motor is driven by the second drive signal is opposite to a rotating direction of the motor when the motor is driven by the first drive signal.

6. The apparatus of claim 4, wherein the constant voltage part comprises:
a voltage output terminal that outputs the constant voltage as controlled by the voltage adjusting circuit;
an internal current source that generates a constant current; and
a current output terminal that outputs the constant current;
wherein the voltage adjusting circuit comprises:
a first node connected to the voltage output terminal of the constant voltage part;
a second node connected to the current output terminal of the constant voltage part;
a ground;
a first resistor connected between the first node and the second node;
a second resistor connected between the second node and the ground;
a third resistor comprising a first terminal and a second terminal, the first terminal being connected to the second node; and
a switch responsive to the control unit and comprising a third terminal and a fourth terminal, the third terminal being connected to the second terminal of the third resistor and the fourth terminal connected to the ground so that the third resistor and the switch are connected in series between the second node and the ground; and
wherein the control unit selectively turns the switch on and off.

7. The apparatus of claim 6, wherein when the mechanical locking has not occurred between the thread part of the lead screw and the moving member, the control unit turns the switch on to control the constant voltage outputted from the constant voltage part to be the normal voltage, thereby causing the motor driving part to generate and output the first drive signal; and
wherein when the mechanical locking has occurred between the thread part of the lead screw and the moving member, the control unit turns the switch off to control the constant voltage outputted from the constant voltage part to be the raised voltage, thereby causing the motor driving part to generate and output the second drive signal.

8. The apparatus of claim 7, wherein a magnitude Vcc_on of the normal voltage that is outputted from the constant voltage part when the switch is turned on is expressed by the following equation:
$$Vcc\_on = {V}_{ref} ( 1 + \frac{R 2 ‖ R 3 )}{R 1} ) + Iadj \cdot ( R 2 ‖ R 3 ) \\ wherein \text{:} \\ R 2 ‖ R 3 = \frac{( R 2 \cdot R 3 )}{( R 2 + R 3 )} ;$$
Vref is an internal reference voltage of the constant voltage part;
Iadj is the constant current generated by the internal current source of the constant voltage part;
R1 is a resistance value of the first resistor;
R2 is a resistance value of the second resistor; and
R3 is a resistance value of the third resistor.

9. The apparatus of claim 7, wherein a magnitude Vcc_off of the raised voltage that is outputted from the constant voltage part when the switch is turned off is expressed by the following equation:
$$Vcc\_off = {V}_{ref} ( 1 + \frac{R 2}{R 1} ) + Iadj \cdot R 2$$
wherein:
Vref is an internal reference voltage of the constant voltage part;
Iadj is the constant current generated by the internal current source of the constant voltage part;
R1 is a resistance value of the first resistor;
R2 is a resistance value of the second resistor; and
R3 is a resistance value of the third resistor.

10. The apparatus of claim 1, wherein the motor is a step motor; and
wherein the control unit controls a rotating direction and a rotating angle of the step motor.

11. The apparatus of claim 1, further comprising a nut comprising a threaded hole;
wherein the nut is integrally coupled to the moving member;
wherein the moving member comprises a lead screw insertion hole provided in a portion of the moving member where the nut is integrally coupled to the moving member so that the lead screw insertion hole is aligned with the threaded hole of the nut; and
wherein the lead screw is inserted through the threaded hole of the nut and the lead screw insertion hole so that the thread part of the lead screw engages the threaded hole of the nut.

12. The apparatus of claim 1, wherein the moving member comprises a threaded lead screw insertion hole; and
wherein the lead screw is inserted into the threaded lead screw insertion hole so that the thread part of the lead screw engages the threaded lead screw insertion hole.

13. An optical disc drive comprising:
a motor that is rotatable;
a lead screw comprising a thread part, the lead screw being rotatably coupled to the motor so that the lead screw rotates when the motor rotates;
a lens;
a lens holder having the lens mounted thereon, the lens holder being reciprocatably coupled to the thread part of the lead screw so that the lens holder moves in a first direction when the lead screw is rotated in a first rotary direction by the motor, and moves in a second direction opposite to the first direction when the lead screw is rotated in a second rotary direction opposite to the first rotary direction by the motor, thereby changing a position of the lens mounted on the lens holder, wherein if the lead screw is rotated too far in the first rotary direction, a mechanical locking occurs between the thread part of the lead screw and the lens holder; and
a control unit that controls a magnitude of electric power supplied to the motor so that when the mechanical locking has occurred between the thread part of the lead screw and the lens holder, the motor generates a torque having a magnitude and a direction effective to release the mechanical locking.

14. The optical disc drive of claim 13, further comprising a servo circuit that generates a drive signal to control a torque and a rotating direction of the motor under control of the control unit, and outputs the drive signal to the motor.

15. The optical disc drive of claim 14, wherein the servo circuit comprises:
a constant voltage part that outputs a constant voltage;
a voltage adjusting circuit, connected to the constant voltage part and responsive to the control unit, that selectively controls the constant voltage outputted from the constant voltage part to be a normal voltage or a raised voltage higher than the normal voltage under the control of the control unit; and
a motor driving part that receives the constant voltage outputted from the constant voltage part as controlled by the voltage adjusting circuit, generates the drive signal based on a magnitude of the constant voltage outputted from the constant voltage as controlled by the voltage adjusting circuit, and outputs the drive signal to the motor;
wherein the drive signal causes the motor to generate a torque having a magnitude proportional to the magnitude of the constant voltage outputted from the constant voltage part as controlled by the voltage adjusting circuit.

16. The optical disc drive of claim 15, wherein the drive signal comprises:
a first drive signal that drives the motor to rotate the lead screw when the mechanical locking has not occurred, the first drive signal being generated based on a magnitude of the normal voltage; and
a second drive signal that drives the motor to rotate the lead screw with the torque having the magnitude and the direction effective to release the mechanical locking when the mechanical locking has occurred, the second drive signal being generated based on a magnitude of the raised voltage.

17. The optical disc drive of claim 16, wherein a torque generated by the motor when the motor is driven by the second drive signal is greater than a torque generated by the motor when the motor is driven by the first drive signal; and
wherein a rotating direction of the motor when the motor is driven by the second drive signal is opposite to a rotating direction of the motor when the motor is driven by the first drive signal.

18. The optical disc drive of claim 16, wherein the constant voltage part comprises:
a voltage output terminal that outputs the constant voltage as controlled by the voltage adjusting circuit;
an internal current source that generates a constant current; and
a current output terminal that outputs the constant current;
wherein the voltage adjusting circuit comprises:
a first node connected to the voltage output terminal of the constant voltage part;
a second node connected to the current output terminal of the current voltage part;
a ground;
a first resistor connected between the first node and the second node;
a second resistor connected between the second node and the ground;
a third resistor comprising a first terminal and a second terminal, the first terminal being connected to the second node; and
a switch responsive to the control unit and comprising a third terminal and a fourth terminal, the third terminal being connected to the second terminal of the third resistor and the fourth terminal being connected to the ground so that the third resistor and the switch are connected in series between the second node and the ground; and
wherein the control unit selectively turns the switch on and off.

19. The optical disc drive of claim 18, wherein when the mechanical locking has not occurred between the thread part of the lead screw and the lens holder, the control unit turns the switch on to control the constant voltage outputted from the constant voltage part to be the normal voltage, thereby causing the motor drive part to generate and output the first drive signal; and
wherein when the mechanical locking has occurred between the thread part of the lead screw and the lens holder, the control unit turn the switch off to control the constant voltage outputted from the constant voltage part to be the raised voltage, thereby causing the motor driving part to generate and output the second drive signal.

20. The optical disc drive of claim 19, wherein a magnitude Vcc_on of the normal voltage that is outputted from the constant voltage part when the switch is turned on is expressed by the following equation:
$$Vcc\_on = {V}_{ref} ( 1 + \frac{R 2 ‖ R 3 )}{R 1} ) + Iadj \cdot ( R 2 ‖ R 3 ) \\ wherein \text{:} \\ R 2 ‖ R 3 = \frac{( R 2 \cdot R 3 )}{( R 2 + R 3 )} ;$$
Vref is an internal reference voltage of the constant voltage part;
Iadj is the constant current generated by the internal current source of the constant voltage part;
R1 is a resistance value of the first resistor;
R2 is a resistance value of the second resistor; and
R3 is a resistance value of the third resistor.

21. The optical disc drive of claim 19, wherein a magnitude Vcc_off of the raised voltage that is outputted from the constant voltage part when the switch is turned off is expressed by the following equation:
$$Vcc\_off = {V}_{ref} ( 1 + \frac{R 2}{R 1} ) + Iadj \cdot R 2$$
wherein:
Vref is an internal reference voltage of the constant voltage part;
Iadj is the constant current generated by the internal current source of the constant voltage part;
R1 is a resistance value of the first resistor;
R2 is a resistance value of the second resistor; and
R3 is a resistance value of the third resistor.

22. The optical disc drive of claim 13, wherein the lens mounted on the lens holder is a collimating lens that focuses light.

23. The optical disc drive of claim 22, wherein the collimating lens is disposed on an optical axis;
wherein the optical disc drive further comprises an object lens disposed on the optical axis; and
wherein the lens holder moves the collimating lens relative to the object lens along the optical axis when the lens holder moves in the first direction and the second direction.

24. The optical disc drive of claim 13, wherein the motor is a step motor; and
wherein the control unit controls a rotating direction and a rotating angle of the step motor.

25. The optical disc drive of claim 13, further comprising a nut comprising a threaded hole;
wherein the nut is integrally coupled to the lens holder;
wherein the lens holder comprises a lead screw insertion hole provided in a portion of the lens holder where the nut is integrally coupled to the lens holder so that the lead screw insertion hole is aligned with the threaded hole of the nut; and
wherein the lead screw is inserted through the threaded hole of the nut and the lead screw insertion hole so that the thread part of the lead screw engages the threaded hole of the nut.

26. The optical disc drive of claim 13, wherein the lens holder comprises a threaded lead screw insertion hole; and
wherein the lead screw is inserted into the threaded lead screw insertion hole so that the thread part of the lead screw engages the threaded lead screw insertion hole.

27. A method of controlling an optical disc drive, the optical disc drive comprising:
a motor that is rotatable;
a lead screw comprising a thread part, the lead screw being rotatably coupled to the motor so that the lead screw rotates when the motor rotates;
a lens; and
a lens holder having the lens mounted thereon, the lens holder being reciprocatably coupled to the thread part of the lead screw so that the lens holder moves in a first direction when the lead screw is rotated in a first rotary direction by the motor, and moves in a second direction opposite to the first direction when the lead screw is rotated in a second rotary direction opposite to the first rotary direction by the motor, thereby changing a position of the lens mounted on the lens holder, wherein if the lead screw is rotated too far in the first rotary direction, a mechanical locking occurs between the thread part of the lead screw and the lens holder;
the method comprising:
supplying electric power to the motor to drive the motor to rotate the lead screw;
monitoring whether the mechanical locking has occurred between the lead screw and the lens holder; and
when the mechanical locking has occurred between the thread part of the lead screw and the lens holder, controlling a magnitude of the electric power supplied to the motor so that the motor generates a torque having a magnitude and a direction effective to release the mechanical locking.

28. The method of claim 27, further comprising:
controlling the magnitude of the electric power supplied to the motor so that a torque generated by the motor when the mechanical locking has occurred is greater than a torque generated by the motor when the mechanical locking has not occurred; and
controlling a rotating direction of the motor so that a rotating direction of the motor when the mechanical locking has occurred is opposite to a rotating direction of the motor when the mechanical locking has not occurred.

29. The method of claim 27, wherein the optical disc drive has an optical disc loaded therein;
wherein the optical disc loaded in the optical disc drive produces spherical aberration; and
wherein the supplying of electric power to the motor to drive the motor to rotate the lead screw comprises supplying electric power to the motor to drive the motor to rotate the lead screw to move the lens holder to change the position of the lens to correct the spherical aberration of the optical disc loaded in the optical disc drive.

30. The method of claim 27, further comprising giving an alarm and interrupting operation of the motor if the mechanical locking is not released by the controlling of the magnitude of the electric power supplied to the motor so that the motor generates a torque having a magnitude and a direction effective to release the mechanical locking.
